(19) United States
(12) Patent Application Publication
(10) Pub. No.: US 2026/0257791 A1
(43) Pub. Date: Sep. 3, 2026

(54) INDIVIDUAL AIRCRAFT AND AIR TRANSPORT SYSTEM

(71) Applicant: Rensselaer Polytechnic Institute, Troy, NY (US)

(72) Inventor: Qisong Gao, Troy, NY (US)

(73) Assignee: Rensselaer Polytechnic Institute, Troy, NY (US)

(21) Appl. No.: 18/870,854

(22) PCT Filed: May 31, 2023
(86) PCT No.: PCT/US2023/023928

§ 371 Date: Dec. 2, 2024

Related U.S. Application Data
(60) Provisional application No. 63/347,181, filed on May 31, 2022.

(51) Int. Cl. B64C 39/00; B64C 11/00; B64C 11/48; B64C 39/02

(52) U.S. Cl. CPC B64C 39/006; B64C 39/026; B64C 11/001; B64C 11/48

(57) ABSTRACT

An individual transport aircraft includes a body and a lift generation system. The body includes a top side, a bottom side, a perimeter wall including an interior circumferential surface that defines an annular opening in the body, and a core centrally located in the opening. The core includes an exterior circumferential surface that is concentric with and faces the interior circumferential surface of the perimeter wall. The lift generation system includes an outer rotor and an inner rotor that are concentrically positioned in the opening. The outer rotor is configured to rotate about a central axis of the opening in a first direction to generate lift in an upward direction. The inner rotor is configured to rotate about the central axis in a second direction opposite the first direction to generate lift in the upward direction. The outer rotor and the inner rotor are suspended and rotated via magnetic levitation.

### CROSS REFERENCE TO RELATED APPLICATIONS

This application claims the priority benefit of U.S. Provisional Patent Application No. 63/347,181, filed May 31, 2022, which is incorporated by reference as if disclosed herein in its entirety.

### FIELD

The present technology relates generally to the field of aircrafts, and more particularly, to aircrafts and networks for local transportation of individuals.

### BACKGROUND

Nowadays traffic is a very serious problem. Especially for people living in big cities, traffic jams bring inconvenience every day. It is not only during commuting on weekdays, but also on weekends in big cities. Going out as a family, eating out, or going for an outing can be inconvenient. Drivers sometimes must wait a long time for the road to be clear. Others are forced to take public transport to reduce traffic jams, for example, taking subways.

Many cities around the world have started using helicopters to address these problems. The problem with this solution, however, is that it is expensive and not applicable to the general public. Additionally, helicopters need pilots, and there are not enough operational helicopters to make large-scale city traveling feasible.

What is needed, therefore, is an improved air transport system that addresses at least the problems described above.

### SUMMARY

According to an embodiment of the present technology, an individual transport aircraft is provided. The aircraft includes a body and a lift generation system. The body includes a top side; a bottom side; a perimeter wall connecting the top side and the bottom side, the perimeter wall includes an interior circumferential surface that defines an annular opening in the body; and a core centrally located in the opening. The core includes an exterior circumferential surface that is concentric with and faces the interior circumferential surface of the perimeter wall. The lift generation system includes an outer rotor and an inner rotor. The outer rotor is positioned between the interior circumferential surface of the perimeter wall and the exterior circumferential surface of the core. The outer rotor is configured to rotate about a central axis of the opening in a first direction to generate lift in an upward direction away from the top side of the body. The inner rotor is positioned between the outer rotor and the exterior circumferential surface of the core. The inner rotor is configured to rotate about the central axis in a second direction opposite the first direction to generate lift in the upward direction.

In some embodiments, the outer rotor and the inner rotor are each suspended between the top side and the bottom side by magnetic levitation.

In some embodiments, the outer rotor includes an annular frame that has an exterior surface and an interior surface. The exterior surface has a plurality of airfoils attached thereto. Each of the airfoils have a distal end that faces the interior circumferential surface of the perimeter wall.

In some embodiments, each of the airfoils include a magnet at the distal end. The magnet has north and south poles facing the interior circumferential surface of the perimeter wall. The interior circumferential surface of the perimeter wall includes a plurality of magnets arranged in an alternating polarity pattern such that interactions between the outer rotor magnets and the perimeter wall magnets rotates the outer rotor.

In some embodiments, the outer rotor magnets are superconducting magnets, and the perimeter wall magnets are electromagnets.

In some embodiments, the inner rotor includes an annular frame that has an exterior surface and an interior surface. The interior surface has a plurality of airfoils attached thereto. Each of the airfoils has a distal end that faces the exterior circumferential surface of the core.

In some embodiments, each of the airfoils include a magnet at the distal end. The magnet has north and south poles facing the exterior circumferential surface of the core. The exterior circumferential surface of the core includes a plurality of magnets arranged in an alternating polarity pattern such that interaction between the inner rotor magnets and the core magnets rotates the inner rotor.

In some embodiments, the inner rotor magnets are superconducting magnets, and the core magnets are electromagnets.

In some embodiments, the interior surface of the outer rotor is positioned adjacent the exterior surface of the inner rotor.

In some embodiments, the outer rotor and the inner rotor are suspended at a substantially level positioning along the central axis by a magnetic levitation system. In some embodiments, the positioning and angles of the outer rotor and the inner rotor are adjustable by the magnetic levitation system.

In some embodiments, a user compartment is on top of the core for housing an individual being transported by the aircraft.

According to another embodiment of the present technology, a magnetic levitation lift generation system is provided. The system includes a rotor housing, an outer rotor, and an inner rotor. The rotor housing has a perimeter wall that includes an interior circumferential wall defining an annular opening, and a core centrally located in the opening. The core includes an exterior circumferential surface that is concentric with and facing the interior circumferential surface of the perimeter wall. The outer rotor is positioned between the interior circumferential surface of the perimeter wall and the exterior circumferential surface of the core. The outer rotor is configured to rotate about a central axis of the opening in a first direction to generate lift in an upward direction away from a top side of the housing. The inner rotor is positioned between the outer rotor and the exterior circumferential surface of the core. The inner rotor is configured to rotate about the central axis in a second direction opposite the first direction to generate lift in the upward direction. The outer rotor and the inner rotor are suspended at a substantially level positioning along the central axis by a magnetic levitation system.

In some embodiments, the positioning and angles of the outer rotor and the inner rotor are adjustable by the magnetic levitation system.

In some embodiments, the outer rotor includes an annular frame that has an exterior surface and an interior surface. The exterior surface has a plurality of airfoils attached thereto. Each of the airfoils have a distal end that faces the interior circumferential surface of the perimeter wall.

In some embodiments, each of the airfoils include a magnet at the distal end. The magnet has north and south poles facing the interior circumferential surface of the perimeter wall. The interior circumferential surface of the perimeter wall includes a plurality of magnets arranged in an alternating polarity pattern such that interactions between the outer rotor magnets and the perimeter wall magnets rotates the outer rotor.

In some embodiments, the outer rotor magnets are superconducting magnets, and the perimeter wall magnets are electromagnets.

In some embodiments, the inner rotor includes an annular frame that has an exterior surface and an interior surface. The interior surface has a plurality of airfoils attached thereto. Each of the airfoils has a distal end that faces the exterior circumferential surface of the core.

In some embodiments, each of the airfoils include a magnet at the distal end. The magnet has north and south poles facing the exterior circumferential surface of the core. The exterior circumferential surface of the core includes a plurality of magnets arranged in an alternating polarity pattern such that interaction between the inner rotor magnets and the core magnets rotates the inner rotor.

In some embodiments, the inner rotor magnets are superconducting magnets, and the core magnets are electromagnets.

In some embodiments, the interior surface of the outer rotor is positioned adjacent the exterior surface of the inner rotor.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a perspective view of an individual transport aircraft with Detail A showing a portion of the lift generation system of the aircraft according to an embodiment of the present technology.

FIG. 2 is a perspective cross-sectional view of the aircraft taken along section B-B of FIG. 1.

FIG. 3 is a side elevation cross sectional view of Detail D of FIG. 2.

FIG. 4 is a perspective view of portions of the outer rotor of the lift generation system according to an embodiment of the present technology.

FIG. 5 is a perspective view of portions of the inner rotor of the lift generation system according to an embodiment of the present technology.

FIG. 6 is a perspective view of a portion of the lift generation system according to an embodiment of the present technology.

### DETAILED DESCRIPTION

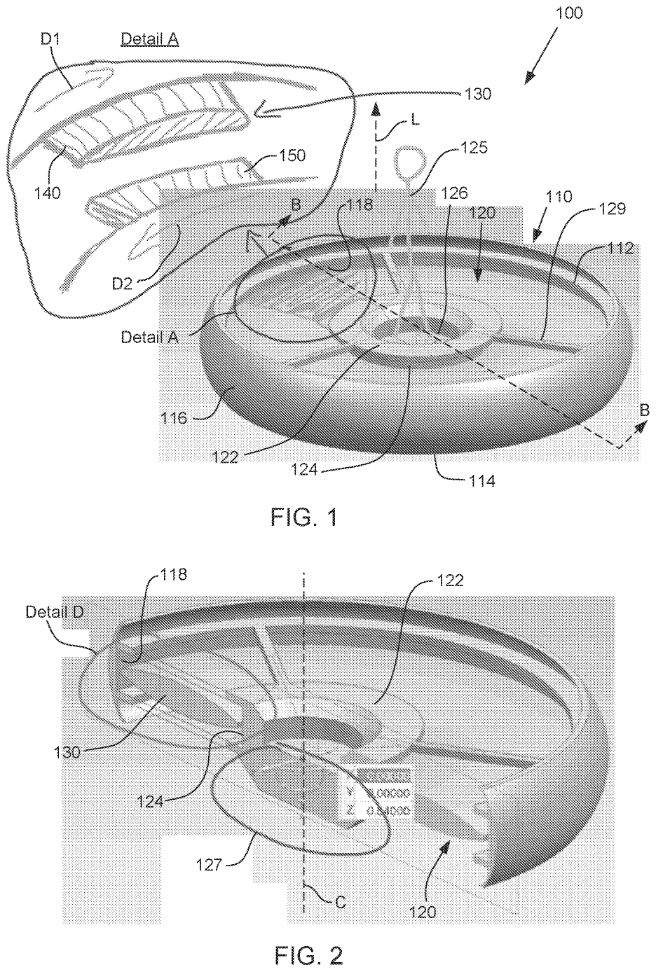

As shown in FIG. 1, an individual transport aircraft is generally designated by the numeral 100. The aircraft 100 includes a body (also referred to herein as a rotor housing) 110 that has a top side 112, a bottom side 114, and a perimeter wall 116 that connects the top side 112 and the bottom side 114. The perimeter wall 116 has an interior circumferential surface 118 that defines an annular opening 120 in the body 110. A core 122 is centrally located in the opening 120. The core 122 has an exterior circumferential surface 124 that is concentric with and faces the interior circumferential surface 118 of the perimeter wall 116. In some embodiments, the core 122 has a user compartment 126 at the top side 112 for housing an individual 125 being transported by the aircraft 100. In some embodiments, the user compartment 126 includes a standing platform. In some embodiments, the user compartment 126 includes a seating area. In some embodiments, the user compartment 126 includes an enclosed structure, such as a cockpit. In some embodiments, the core 122 includes a power storage compartment 127 positioned below the user compartment 126, as shown in FIG. 2. In some embodiments, the power storage compartment 127 includes a battery and an electric motor powered by the battery. In some embodiments, the power storage compartment 127 includes a plurality of electric motors powered by a plurality of batteries. In some embodiments, the core 122 is connected to the perimeter wall 116 via spokes 129. In some embodiments, the body 110 has a disc-like shape, however the present technology contemplates the body 110 having other shapes provided that the opening 120 remains annular in shape.

The aircraft 100 includes a lift generation system 130 positioned in the opening 120, as shown in FIGS. 1-2. As shown in Detail A of FIG. 1, the lift generation system 130 includes an outer rotor 140 and an inner rotor 150. The outer rotor 140 is positioned between the interior circumferential surface 118 of the perimeter wall 116 and the exterior circumferential surface 124 of the core 122. The inner rotor 150 is positioned between the outer rotor 140 and the exterior circumferential surface 124 of the core 122. The outer rotor 140 is configured to rotate about a central axis C of the opening 120 in a first direction D1 to generate lift L in an upward direction away from the top side 112 of the body 110. The inner rotor 150 is configured to rotate about the central axis C in a second direction D2 to also generate lift L in the upward direction away from the top side 112 of the body 110. The second direction D2 is opposite the first direction D1 (e.g., in some embodiments D1 is clockwise and D2 is counterclockwise) such that the rotations of the outer rotor 140 and the inner rotor 150 in the different directions cancel their respective torque, resulting in improved stability of the aircraft 100 during flight.

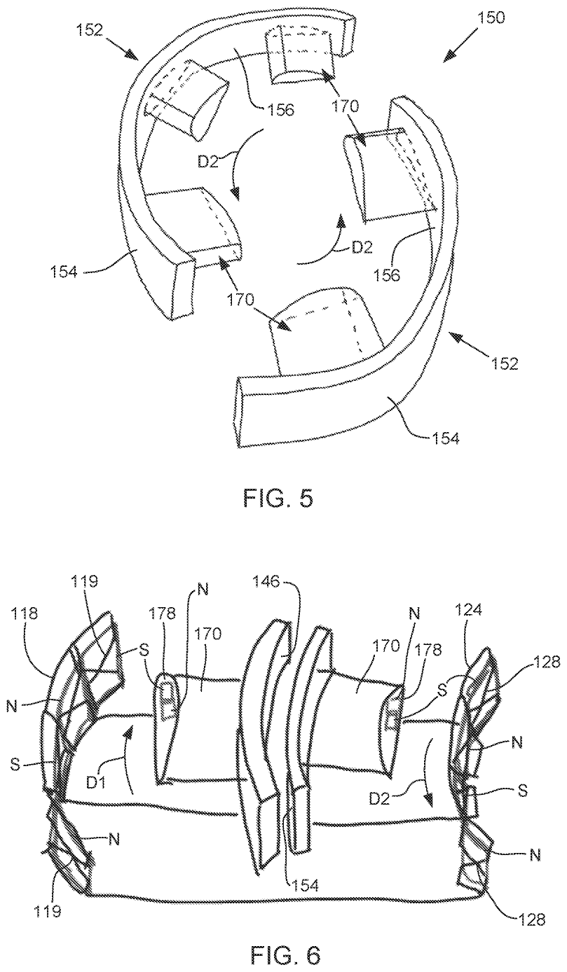

As shown in FIG. 4, the outer rotor 140 includes an annular frame 142 that has an exterior surface 144 and an interior surface 146. The exterior surface 144 has a plurality of airfoils 170 attached thereto. As shown in FIG. 5, the inner rotor 150 includes an annular frame 152 that has an exterior surface 154 and an interior surface 156. The interior surface 156 has a plurality of airfoils 170 attached thereto. As shown in FIG. 4, each airfoil 170 has a leading edge 171, a trailing edge 172, an upper surface 173, a lower surface 174, a proximal end 175, and a distal end 176. The airfoil 170 is aerodynamically shaped such that as it is rotated the air flowing around it creates a lower pressure above the airfoil 170 and a higher pressure below the airfoil 170, resulting in the lift L generated. For the outer rotor 140, the proximal end 175 of the airfoil 170 is attached to the exterior surface 144, and the distal end 176 faces the interior circumferential surface 118 of the perimeter wall 116. For the inner rotor 150, the proximal end 175 of the airfoil 170 is attached to the interior surface 156, and the distal end 176 faces the exterior circumferential surface 124 of the core 122. As shown in FIG. 6, the inner surface 146 of the outer rotor 140 is positioned adjacent the exterior surface 154 of the inner rotor 150.

As shown in FIG. 6, each airfoil 170 has a magnet 178 positioned at the distal end 176 thereof. The magnet 178 has a north pole N and a south pole S that are arranged such that they each face the respective circumferential surface 118, 124 (i.e., the magnets 178 of the outer rotor 140 face the interior circumferential surface 118 and the magnets 178 of the inner rotor 150 face the exterior circumferential surface 124). In some embodiments, the magnets 178 are superconducting magnets. In some embodiments, the magnets 178 are permanent magnets. The interior circumferential surface 118 has a plurality of magnets 119 positioned thereon. Each magnet 119 has a north polarity N or a south polarity S, and the plurality of magnets 119 are arranged in an alternating polarity pattern (i.e., N, S, N, S, N, S, etc.) such that the attraction and repulsion forces resulting from the interaction of the outer rotor magnets 178 and the perimeter wall magnets 119 generates the rotational force driving the rotation of the outer rotor 140 in the first direction D1. The exterior circumferential surface 124 has a plurality of magnets 128 positioned thereon. Each magnet 128 has a north polarity N or a south polarity S, and the plurality of magnets 128 are arranged in an alternating polarity pattern (i.e., N, S, N, S, N, S, etc.) such that the attraction and repulsion forces resulting from the interaction of the inner rotor magnets 178 and the core magnets 128 generates the rotational force driving the rotation of the inner rotor 150 in the second direction D2.

In some embodiments, the perimeter wall magnets 119 and the core magnets 128 are electromagnets. In some embodiments, the electromagnets 119, 128 are in electrical communication with a computer that is in electrical communication with the power storage compartment 127 of the core 122. The computer is configured to control the direction of the current provided to the electromagnets 119, 128 by the electric motor of the power storage compartment 127. By changing the direction of the current, the computer can change the polarity of the electromagnets 119, 128. In some embodiments, the electromagnets 119, 128 each include a figure-eight shaped coil, as shown in FIG. 6.

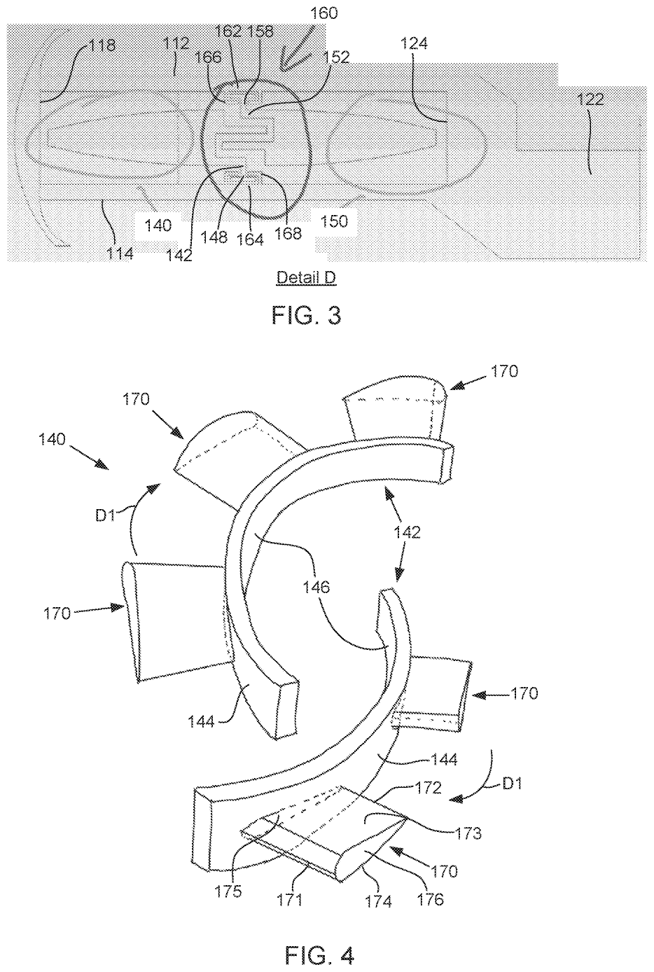

As shown in FIG. 3, in some embodiments, the outer rotor 140 and the inner rotor 150 are each suspended between the top side 112 and the bottom side 114 of the body 110 by a magnetic levitation system 160. In some embodiments, the magnetic levitation system 160 includes an upper magnet 162 attached to a lower surface 113 of the top side 112 of the body 110, and a lower magnet 164 attached to an upper surface 115 of the bottom side 114 of the body 110. In some embodiments, the upper magnet 162 and the lower magnet 164 are each substantially horseshoe shaped thereby defining respective upper channel 166 and lower channel 168. In some embodiments, the upper channel 166 is configured to retain a magnetic flange 158 located on the top of the annular frame 152 of the inner rotor 150. The polarities of the upper magnet 162 and the magnetic flange 158 are configured such that the magnetic flange 158 is suspended within the upper channel 166 via magnetic levitation, thereby suspending the inner rotor 150 within the opening 120. In some embodiments, the lower channel 168 is configured to retain a magnetic flange 148 located on the bottom of the annular frame 142 of the outer rotor 140. The polarities of the lower magnet 164 and the magnetic flange 148 are configured such that the magnetic flange 148 is suspended within the lower channel 168 via magnetic levitation, thereby suspending the outer rotor 140 within the opening 120. In some embodiments, the outer rotor 140 is suspended via the upper channel 166 and the inner rotor 150 is suspended via the lower channel 168. In some embodiments, the upper magnet 162 and the lower magnet 164 are electromagnets. In some embodiments, the magnetic levitation system 160 is configured to suspend the outer rotor 140 and the inner rotor 150 at substantially the same positioning as measured along the central axis C (i.e., the outer rotor 140 and the inner rotor 150 are levitated at substantially the same level). In some embodiments, the magnetic levitation system 160 is configured to adjust the angle of the outer rotor 140 and the inner rotor 150, thereby adjusting the direction of the lift L generated by the aircraft 100 such that a horizontal component of the lift L serves as thrust for the aircraft 100.

In some embodiments, the user compartment 126 includes flight controls for manual flight operations performed by the individual being transported by the aircraft 100. In some embodiments, a flight computer is in electrical communication with the power storage compartment 127. The flight computer includes software programming configured to execute autopilot and navigation commands to autonomously transport the individual from a first predetermined transport station to a second predetermined transport station. For example, in some embodiments the first predetermined transport station is a first helipad atop a first building, and the second predetermined transport station is a second helipad atop a second building a distance away from the first building. In some embodiments, the aircraft 100 is remotely controlled autonomously by a network flight computer or manually by a network operator.

Accordingly, exemplary embodiments of the present technology are directed to an individual aircraft and transport system that is configured to better ease the ground traffic through the rational use of air space and solve the inconvenience and waste of time suffered by urban residents in traffic. The aircraft uses magnetic levitation to control the rotors. The advantage of using magnetic levitation is that it can greatly reduce the friction between mechanical parts, thus increasing the rotation speed and saving energy. And driven by magnetic levitation, the main energy source is electricity. Electricity is also clean energy under the condition of global warming. In some embodiments, the magnetic levitation technology is not only applied to rotate the rotors, but also responsible for suspending the rotors in place. Thus, some embodiments of the aircraft do not include mechanical motors or gears. The disc shape design of some embodiments is easier to take off and land, similar to a helicopter. However, unlike a helicopter, it does not have a small tail to offset torque, but two rotors that spin in different directions. Because small tail fins can bring accidents to helicopters, there is a certain risk. The disc design reduces the probability of such an accident.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

1. An individual transport aircraft comprising:
a body comprising:
a top side,
a bottom side,
a perimeter wall connecting the top side and the bottom side, the perimeter wall comprising an interior circumferential surface defining an annular opening in the body; and
a core centrally located in the opening, the core comprising an exterior circumferential surface that is concentric with and facing the interior circumferential surface of the perimeter wall; and
a lift generation system positioned in the opening; the lift generation system comprising:
an outer rotor positioned between the interior circumferential surface of the perimeter wall and the exterior circumferential surface of the core, the outer rotor configured to rotate about a central axis of the opening in a first direction to generate lift in an upward direction away from the top side of the body; and
an inner rotor positioned between the outer rotor and the exterior circumferential surface of the core, the inner rotor configured to rotate about the central axis in a second direction opposite the first direction to generate lift in the upward direction.

2. The aircraft of claim 1, wherein the outer rotor and the inner rotor are each suspended between the top side and the bottom side by magnetic levitation.

3. The aircraft of claim 1, wherein the outer rotor comprises an annular frame having an exterior surface and an interior surface, the exterior surface having a plurality of airfoils attached thereto, each of the airfoils having a distal end that faces the interior circumferential surface of the perimeter wall.

4. The aircraft of claim 3, wherein each of the airfoils comprises a magnet at the distal end, the magnet having north and south poles facing the interior circumferential surface of the perimeter wall; and
the interior circumferential surface of the perimeter wall comprising a plurality of magnets arranged in an alternating polarity pattern such that interaction between the outer rotor magnets and the perimeter wall magnets rotates the outer rotor.

5. The aircraft of claim 4, wherein the outer rotor magnets are superconducting magnets, and the perimeter wall magnets are electromagnets.

6. The aircraft of claim 1, wherein the inner rotor comprises an annular frame having an exterior surface and an interior surface, the interior surface having a plurality of airfoils attached thereto, each of the airfoils having a distal end that faces the exterior circumferential surface of the core.

7. The aircraft of claim 6, wherein each of the airfoils comprises a magnet at the distal end, the magnet having north and south poles facing the exterior circumferential surface of the core; and
the exterior circumferential surface of the core comprising a plurality of magnets arranged in an alternating polarity pattern such that interaction between the inner rotor magnets and the core magnets rotates the inner rotor.

8. The aircraft of claim 7, wherein the inner rotor magnets are superconducting magnets, and the core magnets are electromagnets.

9. The aircraft of claim 6, wherein the interior surface of the outer rotor is positioned adjacent the exterior surface of the inner rotor.

10. The aircraft of claim 9, wherein the outer rotor and the inner rotor are suspended at a substantially level positioning along the central axis by a magnetic levitation system.

11. The aircraft of claim 10, wherein the positioning and angles of the outer rotor and the inner rotor are adjustable by the magnetic levitation system.

12. The aircraft of claim 1, further comprising a user compartment on top of the core for housing an individual being transported by the aircraft.

13. A magnetic levitation lift generation system comprising:
a rotor housing having a perimeter wall comprising an interior circumferential wall defining an annular opening, and a core centrally located in the opening, the core comprising an exterior circumferential surface that is concentric with and facing the interior circumferential surface of the perimeter wall;
an outer rotor positioned between the interior circumferential surface of the perimeter wall and the exterior circumferential surface of the core, the outer rotor configured to rotate about a central axis of the opening in a first direction to generate lift in an upward direction away from a top side of the housing; and
an inner rotor positioned between the outer rotor and the exterior circumferential surface of the core, the inner rotor configured to rotate about the central axis in a second direction opposite the first direction to generate lift in the upward direction;
wherein the outer rotor and the inner rotor are suspended at a substantially level positioning along the central axis by a magnetic levitation system.

14. The system of claim 13, wherein the positioning and angles of the outer rotor and the inner rotor are adjustable by the magnetic levitation system.

15. The system of claim 13, wherein the outer rotor comprises an annular frame having an exterior surface and an interior surface, the exterior surface having a plurality of airfoils attached thereto, each of the airfoils having a distal end that faces the interior circumferential surface of the perimeter wall.

16. The system of claim 15, wherein each of the airfoils comprises a magnet at the distal end, the magnet having north and south poles facing the interior circumferential surface of the perimeter wall; and
the interior circumferential surface of the perimeter wall comprising a plurality of magnets arranged in an alternating polarity pattern such that interaction between the outer rotor magnets and the perimeter wall magnets rotates the outer rotor.

17. The system of claim 16, wherein the outer rotor magnets are superconducting magnets, and the perimeter wall magnets are electromagnets.

18. The system of claim 13, wherein the inner rotor comprises an annular frame having an exterior surface and an interior surface, the interior surface having a plurality of airfoils attached thereto, each of the airfoils having a distal end that faces the exterior circumferential surface of the core.

19. The system of claim 18, wherein each of the airfoils comprises a magnet at the distal end, the magnet having north and south poles facing the exterior circumferential surface of the core; and
the exterior circumferential surface of the core comprising a plurality of magnets arranged in an alternating polarity pattern such that interaction between the inner rotor magnets and the core magnets rotates the inner rotor.

20. The system of claim 19, wherein the inner rotor magnets are superconducting magnets, and the core magnets are electromagnets.

21. The system of claim 18, wherein the interior surface of the outer rotor is positioned adjacent the exterior surface of the inner rotor.
